(19) United States
(12) Patent Application Publication
(10) Pub. No.: US 2017/0153804 A1
(43) Pub. Date: Jun. 1, 2017

(54) DISPLAY DEVICE

(71) Applicant: MINDQUAKE INC., Seoul (KR)

(72) Inventors: Sun Hae KIM, Seoul (KR); Sung Jae HWANG, Seoul (KR)

(73) Assignee: MINDQUAKE INC., Seoul (KR)

(21) Appl. No.: 14/784,940

(22) PCT Filed: Aug. 11, 2015
(86) PCT No.: PCT/KR2015/008376

§ 371 Date: Oct. 15, 2015

(30) Foreign Application Priority Data
Jun. 26, 2015 (KR) 10-2015-0091530

(51) Int. Cl. G06F 3/0488; G06F 3/0482; G06T 11/20

(52) U.S. Cl. CPC G06F 3/04883; G06T 11/203; G06F 3/0482

(57) ABSTRACT

A method of controlling a display device is provided, in which the method includes providing an entry mode to determine an entry into an adult mode or a child mode through a child indentifying interface including a visual object, recognizing a user input in response to the visual object, and providing the adult mode or the child mode based on a degree of similarity between the recognized user input and the visual object, wherein the child mode may be a mode providing a selecting interface to select at least one application and a time limit interface to terminate the application after executing, for a preset period of time, the application selected through the selecting interface.

### TECHNICAL FIELD

The present invention relates to a display device that provides a child mode and an adult mode, and more particularly, to a display device that identifies a child and an adult through a child identifying interface and provides a child mode and an adult mode.

### BACKGROUND ART

Recent diversification of contents has lead to various applications and contents for various age groups, for example, children.

Parents use child applications and contents mainly for calming or distracting children. To meet such a demand from parents, application producers are releasing child applications including various contents and interfaces that attract interest from children to enable the parents to take care of the children with more ease.

### DISCLOSURE OF INVENTION

### Technical Goals

A child may have an insufficient understanding of a concept such as time and thus, may not be readily aware of termination of contents provided through an application or of protracted use of the application. Thus, when a parent of the child terminates the application or takes away a device through which the application is executed, a conflict may occur between the child and the parent.

Also, when the child manipulates the device providing the application, information stored in the device may be lost or the device may malfunction.

### Technical Solutions

According to an aspect of the present invention, there is provided a method of controlling a display device, the method including providing an entry mode to determine an entry into an adult mode or a child mode through a child identifying interface including a visual object, recognizing a user input in response to the visual object, and providing the adult mode or the child mode based on a degree of similarity between the recognized user input and the visual object. The child mode may provide a selecting interface to select at least one application and a time limit interface to terminate the application after executing, for a preset period of time, the application selected through the selecting interface.

### Effects of Invention

According to example embodiments described herein, a mode suitable for each age group may be provided by identifying an adult and a child through a child identifying interface and providing different modes to an adult and a child based on a result of the identifying. Thus, damage to a device and malfunction of the device that may occur due to manipulation of the device by a child may be prevented.

In addition, a child mode in which a child application is executed, only for a preset period of time, and then terminated after the period of time may be provided to improve a time recognition ability of a child and terminate the child application without a conflict between the child and a parent of the child.

Further, various effects may be generated according to example embodiments, which will be described in detail hereinafter.

### BRIEF DESCRIPTION OF DRAWINGS

FIG. 1 is a diagram illustrating an example of a mode change operation of a device.

FIG. 2 illustrates an example of a child mode provided by a device.

FIG. 3 illustrates an example of an adult mode provided by a device.

FIG. 4 is a flowchart illustrating operations of a device in an entry mode.

FIG. 5 illustrates an example of an entry mode providing a child identifying interface.

FIGS. 6A and 6B illustrate examples of determining a degree of similarity.

FIG. 7 illustrates examples of a visual object having different difficulty levels.

FIGS. 8A, 8B, 8C and 8D illustrate examples of providing a character as a visual object.

FIG. 9 illustrates an example of sequentially displaying a visual object.

FIG. 10 illustrates an example of providing a monitoring interface.

FIG. 11 illustrates an example of obtaining touch input data from a user input.

FIG. 12 is a block diagram illustrating an example of a device.

### BEST MODE FOR CARRYING OUT INVENTION

Technical and scientific terms used herein have the same meaning as commonly understood by one of ordinary skill in the art to which example embodiments of the present invention belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Also, terms used herein are defined to appropriately describe example embodiments of the present invention and thus, may be changed depending on the intent of a user or an operator, or a custom. Accordingly, the terms must be defined based on the following overall description of this specification.

Example embodiments to be described hereinafter relate to a display device and a method of controlling the display device. The display device may include various electronic devices, for example, a mobile phone, a personal digital assistant (PDA), a laptop computer, a tablet personal computer (PC), a moving picture experts group (MPEG)-1 or MPEG-2 audio layer 3 (MP3) player, a compact disc (CD) player, a digital versatile disc (DVD) player, a head-mounted display (HMD), a smart watch, a watch phone, and a television (TV), which are configured to display various sets of visual information. Hereinafter, the display device will be also referred to as a device for conciseness.

Hereinafter, the example embodiments will be described in detail with reference to the accompanying drawings.

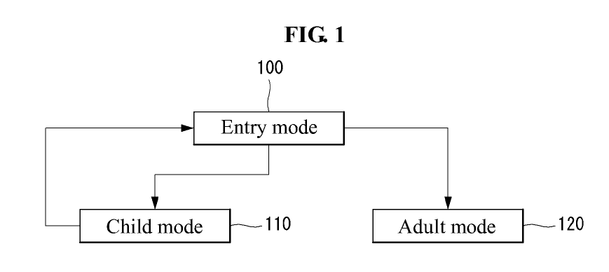

FIG. 1 is a diagram illustrating an example of a mode change operation of a device according to an embodiment.

Referring to FIG. 1, the device provides an entry mode 100, a child mode 110, and an adult mode 120. The device may change a mode, for example, from the entry mode 100 to the child mode 110, from the entry mode 100 to the adult mode 120, or from the child mode 110 back to the entry mode 100, based on a user input.

The entry mode 100 refers to a mode to determine an entry into the child mode 110 or the adult mode 120. The entry mode 100 provides a child identifying interface to identify whether a current user is a child or an adult.

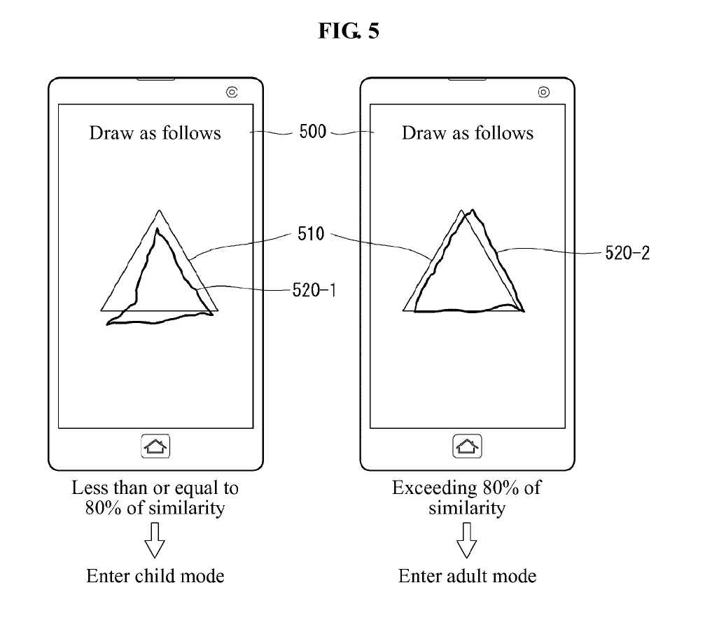

The child identifying interface includes a visual object as a graphic user interface (GUI) provided in the entry mode 100 to identify whether the current user is a child. In the entry mode 100, the device recognizes a user input in response to the visual object provided through the child identifying interface, and identifies whether the current user is a child or an adult based on the recognized user input. The entry mode 100 will be described in more detail with reference to FIGS. 5 through 12.

When the device recognizes the current user as a child through the child identifying interface provided in the entry mode 100, the device may change the entry mode 100 to the child mode 110. Conversely, when the device recognizes the current user as an adult through the child identifying interface provided in the entry mode 100, the device may change the entry mode 100 to the adult mode 120.

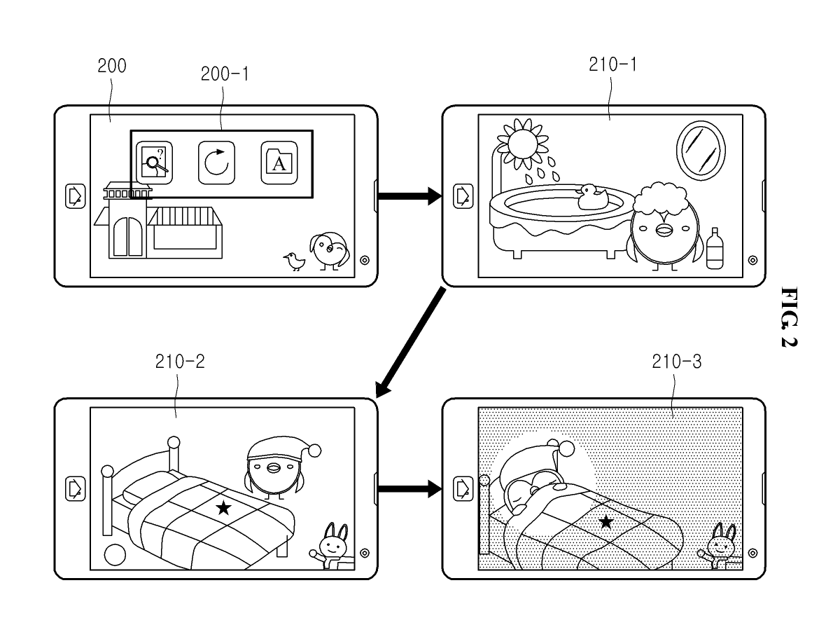

The child mode 110 is provided in the device for a child who is the current user. Thus, the child mode 110 provides a limited function as compared to the adult mode 120. The child mode 110 may provide a more limited type, number, and run time of selectable applications as compared to the adult mode 120 to prevent a device malfunction or damage that may occur to a device due to manipulation by a child, and to improve a time recognition ability of a child. The child mode 110 will be described in more detail with reference to FIG. 2.

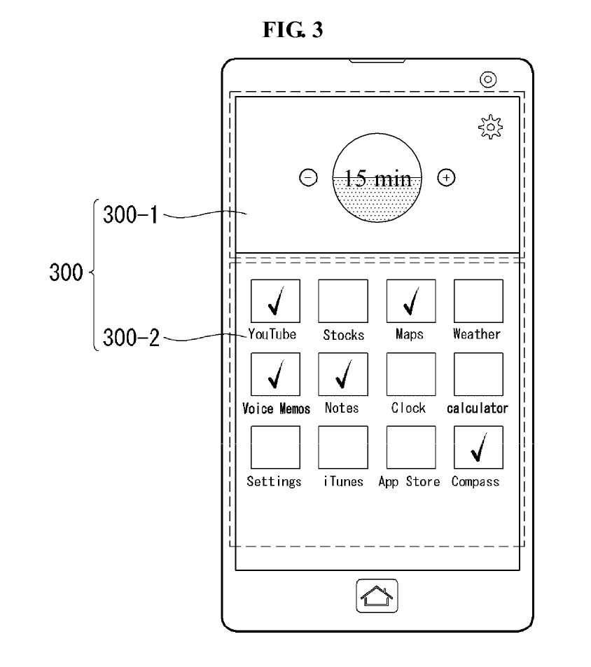

The adult mode 120 is provided in the device for an adult who is the current user. The adult mode 120 provides a setup interface to set a function of the child mode 110. Thus, a parent may set a type, a number, and a run time of applications to be provided in the child mode 110 through the adult mode 120. The adult mode 120 will be described in more detail with reference to FIG. 3.

FIG. 2 illustrates an example of a child mode provided by a device.

Referring to FIG. 2, the child mode provides a selecting interface 200 to support selection of at least one application, and a time limit interface, for example, 210-1 through 210-3, to terminate an application selected through the selecting interface 200 after executing the application for a preset period of time.

The selecting interface 200 supports the selection of at least one application. A type and a number of the application supported by the selecting interface 200 may be set through a setup interface of an adult mode. The selecting interface 200 may provide at least one icon 200-1 as a GUI corresponding to the supported application. A user may select an icon of the application to be executed from the at least one icon 200-1 provided through the selecting interface 200.

The time limit interface 210-1 through 210-3 executes the application corresponding to the icon selected through the selecting interface 200 and then terminates the application after the preset period of time. Here, the period of time may be set through the setup interface in the adult mode. A parent may set a run time of the application through the setup interface to adjust the run time of the application to be provided in the child mode.

However, a child may lack a time recognition ability and thus, may be confused when the application terminates abruptly after the preset period of time elapses. Thus, the time limit interface 210-1 through 210-3 may additionally provide various visual, auditory, and tactile effects at a time of the termination of the application to aid the child in recognizing an arrival of a time for terminating the application. Here, the visual, auditory, and tactile effects refer to effects recognizable through human senses of sight, hearing, and touch.

For example, the time limit interface 210-1 through 210-3 may provide an ending game as a visual effect along with the termination of the application. The ending game may enable a child to naturally recognize a flow of time by providing a game related to a daily life of a character which may go to sleep as a background changes from day to night. Thus, the child may recognize that the time elapses and naturally accept the termination of the application. As an example of the additional visual effect, a screen of the time limit interface 210-3 may fade out at a time of the termination of the ending game.

In addition, the time limit interface 210-1 through 210-3 may include various effects to enable a child to recognize a flow of time and the child may naturally recognize the flow of time through such effects.

An overall function of the child mode may be set through the adult mode. Hereinafter, the adult mode will be described in more detail.

FIG. 3 illustrates an example of an adult mode provided by a device.

Referring to FIG. 3, the adult mode provides a setup interface 300 to set a function of a child mode. The adult mode provides the setup interface 300 to set a number, a type, and a run time of applications that may be provided in the child mode. The setup interface 300 includes, as a sub-interface, a time setup interface 300-1 to set a run time of an application, and an execution setup interface 300-2 to set the number and the type of the applications.

The execution setup interface 300-2 refers to an interface through with the number and the time of the applications executable in the child mode are input or selected. In one example, the execution setup interface 300-2 may provide icons corresponding to all applications that may be supported by the device. A parent may select an icon from the icons to set the number and the type of the applications that may be provided through the child mode. In alternative examples, the execution setup interface 300-2 may receive, from a user, the number and the type of the applications that may be provided in the child mode, or the user may select the number and the type of the applications through the execution setup interface 300-2.

The time setup interface 300-1 refers to an interface through which the run time of the application in the child mode is input or selected. In one example, the time setup interface 300-1 may provide an increase button or a decrease button to increase or decrease the run time of the application. A parent may adjust the run time of the application using the increase button and the decrease button. In alternative examples, the time setup interface 300-1 may receive, from a user, the run time of the application that may be provided in the child mode, or the user may select the run time of the application.

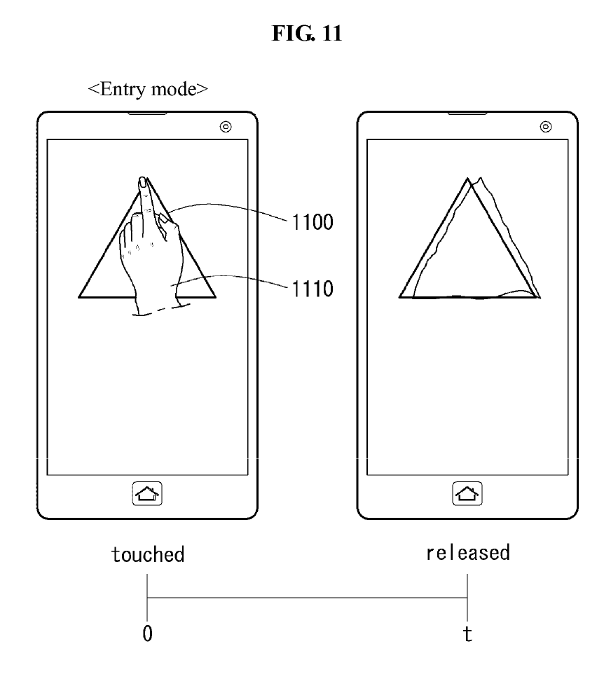

The setup interface 300 may include other various sub-interfaces that may control or monitor the child mode, but not be limited thereto. The setup interface 300 may additionally include a monitoring interface as a sub-interface to monitor an input made to enter an entry mode for a child based on time, which will be described in detail with reference to FIG. 11.

The child mode and the adult mode are described in the foregoing. Hereinafter, an entry mode for identifying a child and an adult and entering the child mode or the adult mode will be described in detail.

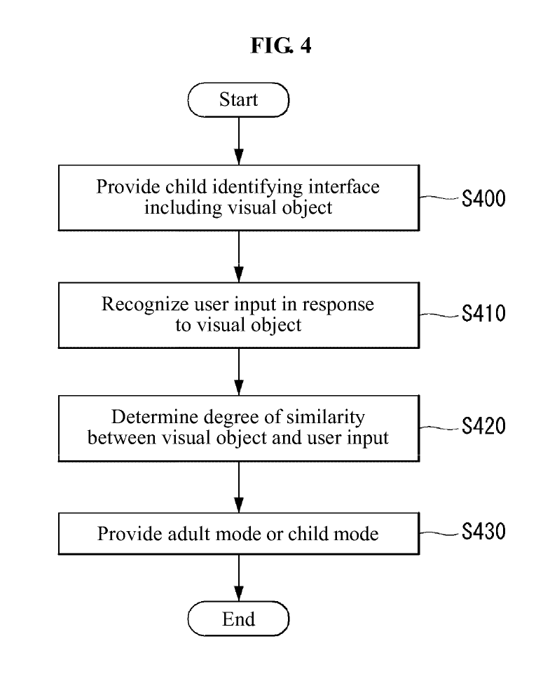

FIG. 4 is a flowchart illustrating operations of a device in an entry mode. The device to be described hereinafter with reference to FIG. 4 refers to a device in the entry mode. FIG. 5 illustrates an example of such an entry mode that provides a child identifying interface.

Referring to FIGS. 4 and 5, in operation S400, the device provides a child identifying interface 500 including a visual object 510. The visual object 510 indicates visual information including at least one line. The line may include a straight line and a curved line.

In operation S410, the device recognizes a user input, for example, a user input 520-1 and a user input 520-2, in response to the visual object 510. Here, the user input 520-1 and 520-2 indicates a touch input from a user that may move along the at least one line included in the visual object 510.

In operation S420, the device determines a degree of similarity between the visual object 510 and the recognized user input 520-1 and 520-2. In detail, the device obtains touch input data from the recognized user input 520-1 and 520-2, and determines the degree of similarity between the visual object 510 and the user input 520-1 and 520-2 by comparing the obtained touch input data to reference data of the visual object 510. Here, the device may receive the reference data from a memory (not shown).

For example, the touch input data refers to data including at least one of a trace, a size, a shape, a location, a length, a thickness, an area, and coordinate information of the recognized user input 520-1 and 520-2. The reference data refers to data including at least one of a trace, a size, a shape, a location, a length, a thickness, an area, and coordinate information of the visual object 510. For example, the device may compare the coordinate information of the user input 520-1 and 520-2 included in the touch input data to the coordinate information of the visual object 510 included in the reference data. When the two sets of the coordinate information are similar, the device may then determine a higher degree of similarity.

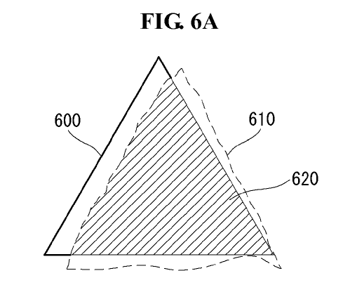

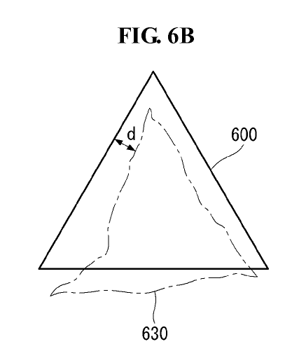

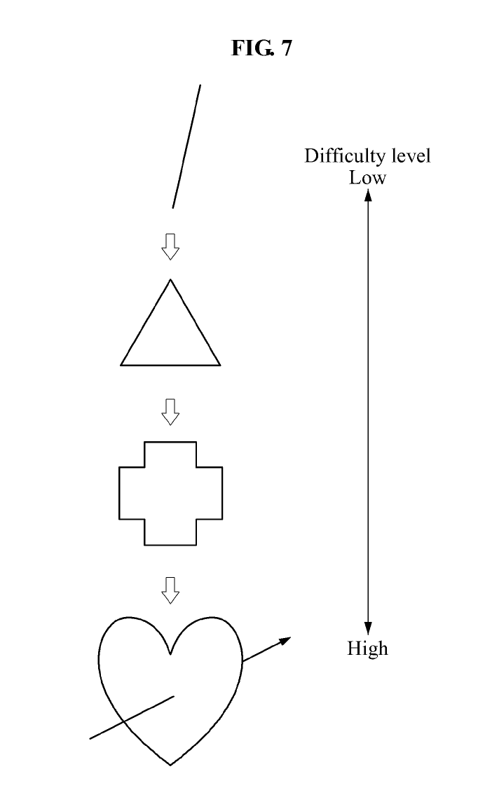

In alternative examples, the device may determine the degree of similarity between the visual object 510 and the user input 520-1 and 520-2 using the touch input data and the reference data, and more detailed description will be provided with reference to FIGS. 6A, 6B, and 7.

In operation S430, the device enters an adult mode or a child mode based on a result of the determining. When the degree of similarity between the visual object 510 and the user input 520-1 and 520-2 is determined to exceed a threshold in operation S420, the device may enter the adult mode. Conversely, when the degree of similarity between the visual object 510 and the user input 520-1 and 520-2 is determined to be less than or equal to the threshold in operation S420, the device may enter the child mode.

For example, when the degree of similarity between the visual object 510 and the user input 520-2 is determined to exceed 80% as a result of comparing the touch input data to the reference data, the device may enter the adult mode. Conversely, when the degree of similarity between the visual object 510 and the user input 520-1 is determined to be less than or equal to 80% as the result of comparing the touch input data to the reference data, the device may enter the child mode.

However, the threshold which is a standard for entering the adult mode or the child mode may not be limited thereto, and be set to be various values. In addition, the threshold may be separately set through a setup interface of the adult mode.

For an adult having a sufficiently developed hand muscle, accurately drawing the displayed visual object 510 may not be a hard task. Thus, the degree of similarity between the visual object 510 and the user input 520-2 made from the adult may be high. Conversely, for a child having an insufficiently developed hand muscle, accurately drawing the displayed visual object 510 may not be an easy task. Thus, the degree of similarity between the visual object 510 and the user input 520-1 made from the child may be low.

Thus, the device may identify the adult and the child by recognizing the user input 520-1 and 520-2 in response to the visual object 510 used for distinguishing the child from the adult and by determining the degree of similarity between the two.

FIGS. 6A and 6B illustrate examples of determining a degree of similarity.

A device may determine a degree of similarity between a user input and a visual object by comparing touch input data to reference data for each category. The device may determine the degree of similarity by comparing same category information included in each of the touch input data and the reference data. For example, the device may determine the degree of similarity by comparing shape information included in the touch input data to shape information included in the reference data.

In addition, the device may obtain additional data using the touch input data and the reference data, and obtain the degree of similarity between the user input and the visual object by comparing the obtained additional data.

In one example, referring to (a) of FIG. 6A, the device obtains, as additional data, an overlapping area 620 using coordinate information included in touch input data of a user input 610 and coordinate information included in reference data of a visual object 600. The device obtains, as a degree of similarity, a ratio of the overlapping area 620 to an area of the visual object 600.

In another example, referring to (b) of FIG. 6B, the device obtains, as additional data, a minimum distance from a feature point of the visual object 600 to a user input 630 using coordinate information included in touch input data of the user input 630 and the coordinate information included in the reference data of the visual object 600. When the obtained minimum distance is smaller, the device may determine a degree of similarity to be higher.

The device may obtain additional data using various sets of information included in the touch input data and the reference data, and determine a degree of similarity using the additionally obtained data.

Further, the device may determine whether the obtained degree of similarity exceeds a threshold, and determine an entry into an adult mode or a child mode.

FIG. 7 illustrates examples of a visual object having different difficulty levels.

Referring to FIG. 7, a difficulty level of a visual object may be adjusted. In response to an increase in the difficulty level, at least one of a number of lines, contact points, intersecting points, and vertices included in the visual object, and a curvature of a line included in the visual object may increase. For example, as illustrated in FIG. 7, based on the increase in the difficulty level, a shape of the visual object may change in an order starting from a straight line, a triangle, a cross, and a heart.

For example, when a child is continuously exposed to a same visual object in an entry mode, a degree of similarity of a touch input made from a child to the visual object may increase. Alternatively, as a child grows and hand muscles of the child develop, a degree of similarity of a touch input made from the child to the visual object may gradually increase.

Thus, in response to such an example, a device according to example embodiments may additionally provide, in an adult mode, a difficulty level setting interface through which the difficulty level of the visual object is set.

A parent may set the difficulty level of the visual object through the difficulty level setting interface, or directly draw the visual object. Alternatively, the parent may set the difficulty level of the visual object to automatically increase at regular intervals through the difficulty level setting interface.

Through the adjusting of the difficulty level of the visual object, the device may adaptively provide the visual object at a difficulty level appropriate as a child grows.

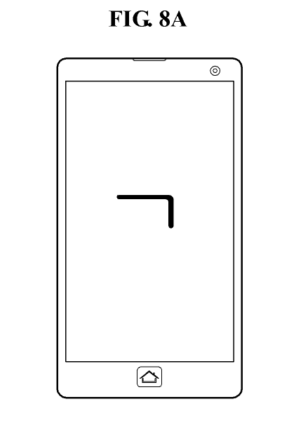

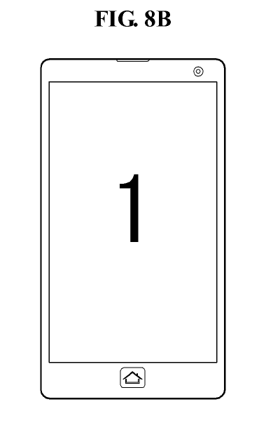

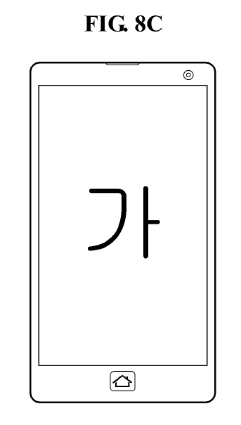

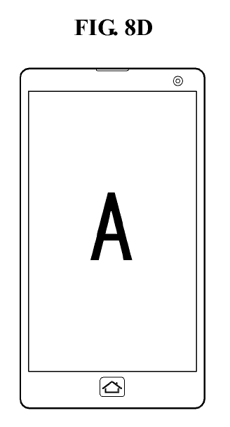

FIGS. 8A, 8B, 8C, and 8D illustrate examples of providing a character as a visual object.

Referring to FIGS. 8A, 8B, 8C, and 8D, a device may provide a character as a visual object. Here, the character indicates various visual symbols to record a speech expressed by a human being. For example, the character may include languages and letters of different countries, for example, vowels and consonants of Korean Hangul, the English alphabet, Japanese Katakana and Hiragana, and Chinese characters, and symbols and numbers. A child may learn more effectively the character by being continuously exposed to the character provided as the visual object and directly drawing the character with a hand.

A setup interface in an adult mode may support a setup of the character as the visual object. Thus, a parent desiring to teach a child a character may teach the child the character by directly setting the character through the setup interface provided in the adult mode.

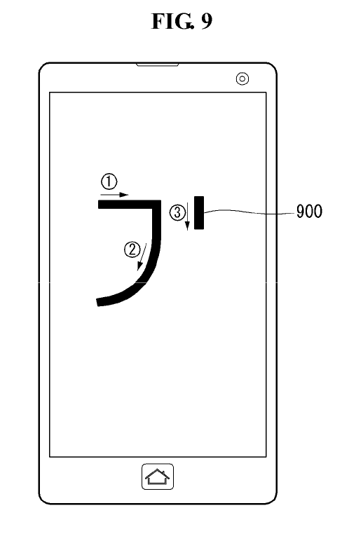

FIG. 9 illustrates an example of sequentially displaying a visual object.

As described with reference to FIGS. 8A, 8B, 8C, and 8D, a character may be provided as a visual object 900 in an entry mode. Here, when entering a child mode by a user input in response to the visual object 900, a device may sequentially display lines included in the visual object 900 prior to an entry into the child mode.

The entry into the child mode indicates that a current user is a child and a degree of similarity between the visual object 900 and the user input is low. Thus, the device may sequentially display the lines included in the visual object 900 based on a preset order before the entry into the child mode to effectively teach the child the character provided as the visual object 900. The device may enable the child to recognize a form of the character and also teach the child how to write the character and thus, the child may learn the character more effectively.

In addition, the device may sequentially display the lines included in the visual object 900 based on the preset order, and simultaneously output a pronunciation of the visual object 900 as an auditory effect.

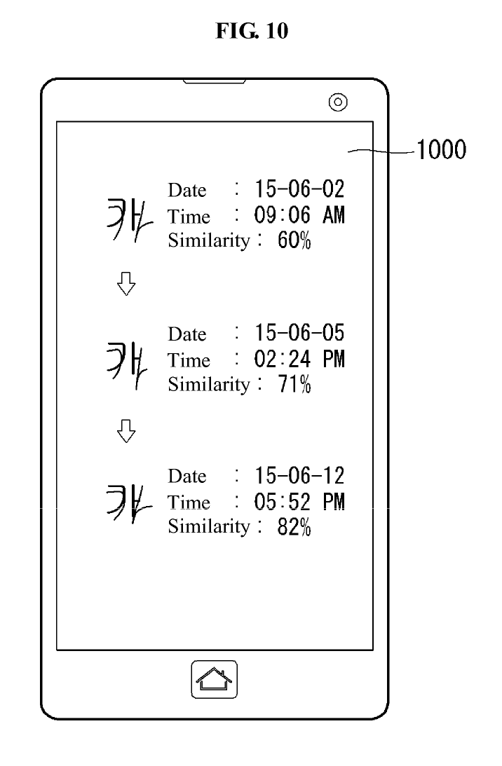

FIG. 10 illustrates an example of providing a monitoring interface.

Referring to FIG. 10, a device provides a monitoring interface 1000 configured to chronologically monitor and provide a user input in an adult mode. The device monitors the user input recognized in an entry mode prior to an entry into a child mode, and provides a result of the monitoring through the monitoring interface 1000 in the adult mode.

When the device enters the child mode after recognizing the user input in the entry mode, the device may store, in a memory, touch input data obtained from the user input. The device may store, in the memory, current time information along with the obtained touch input data. The stored touch input data may be chronologically provided to a user along with the current time information through the monitoring interface 1000 in the adult mode. Here, the monitoring interface 1000 may additionally provide information about a degree of similarity between the user input and a visual object.

A parent may monitor, in real time, a development and a growth of a child of the parent by directly verifying, with eyes, a process in which the degree of similarity between a user input from the child and the visual object increases through the monitoring interface 1000. In addition, when the degree of similarity between the user input from the child and the visual object increases, the parent may increase a difficulty level of the visual object.

Although a visual object is illustrated as a character in FIG. 10, the visual object may not be limited to the character. The descriptions provided in the foregoing may be applied to other examples of a visual object including at least one line.

FIG. 11 illustrates an example of obtaining touch input data from a user input.

When a device identifies a child only using a degree of similarity between a visual object and a user input, accuracy in identifying the child may decrease. Such a case may pertain to when a difficulty level of a visual object is low or a child becoming sufficiently skilled at drawing along the visual object. Thus, the device may more accurately and effectively identify a child by setting an additional identification standard in addition to the degree of similarity between the visual object and the user input.

Referring to FIG. 11, the device may consider a completion time (t) of a user input 1110 to be an additional identification standard. When the device recognizes the user input 1110 in response to a visual object 1100, the device may additionally obtain information about a holding time (t) of the user input 1110. For example, the device may measure the holding time (t) a duration of which extends from a point in time at which the user input 1110 starts in response to the visual object 1100 to a point in time at which the user input 1110 is released. When the holding time (t) of the user input 1110 is less than or equal to a threshold time, the device may determine a current user to be an adult. Conversely, when the holding time (t) exceeds the threshold time, the device may determine the current user to be a child.

Similarly, the device may consider a moving speed of the user input 1110 to be an additional identification standard. In such a case, when the moving speed of the user input 1110 exceeds a threshold speed, the device may determine the current user to be an adult. Conversely, when the moving speed is less than or equal to the threshold speed, the device may determine the current user to be a child.

Although not shown, alternatively, the device may consider a thickness of a user input to be an additional identification standard. When the device recognizes the user input in response to a visual object, the device may additionally obtain information about the thickness of the user input. The device may additionally obtain information about a thickness of at least one line included in the recognized user input. Due to a difference between a thickness of a finger of an adult and a thickness of a finger of a child, a thickness of a line included in a user input made from the adult may be greater than a thickness of a line included in a user input made from the child. Thus, when the thickness of the user input exceeds a threshold thickness, the device may determine a current user to be an adult. Conversely, when the thickness of the user input is less than or equal to the threshold thickness, the device may determine the current user to be a child.

Alternatively, the device may consider a pressure of a user input to be an additional identification standard. When the device recognizes the user input in response to a visual object, the device may additionally obtain the pressure of the user input. The pressure indicates a degree of pressing the device by a user. When the pressure of the user input exceeds a threshold pressure, the device may determine a current user to be an adult. Conversely, when the pressure of the user input is less than or equal to the threshold pressure, the device may determine the current user to be a child.

Alternatively, the device may consider tilt information of the device to be an additional identification standard. For example, when a tilt of the device is less than or equal to a threshold tilt, the device may determine a current user to be an adult. Conversely, when the tilt of the device exceeds the threshold tilt, the device may determine the current user to be a child.

Alternatively, the device may consider an audible frequency of a child to be an additional identification standard. When the device recognizes a user input in response to a visual object, the device may output a sound at the audible frequency of a child, which is a frequency recognizable only through an auditory sense of a child. The device may recognize a response to the sound and identify whether a current user is an adult or a child.

When the device recognizes a user input made from a user who does not respond to the sound, the device may determine the user to be an adult. Conversely, when the device recognizes a user input made from a user who responds to the sound, the device may determine the user to be a child. For example, the user input responsive to the sound indicates an input such as shaking the device or touching the device within a preset period of time after the sound is output. The user input being irresponsive to the sound indicates an input such as no change in the tilt of the device or not touching the device within the preset period of time.

According to example embodiments, the device may more accurately identify an adult or a child by further considering an environment in which the device operates and a form of a user input, in addition to a degree of similarity between a visual object and a user input.

Before the device applies the additional identification standards described in the foregoing, the device may determine that the degree of similarity between the visual object and the user input exceeds the threshold.

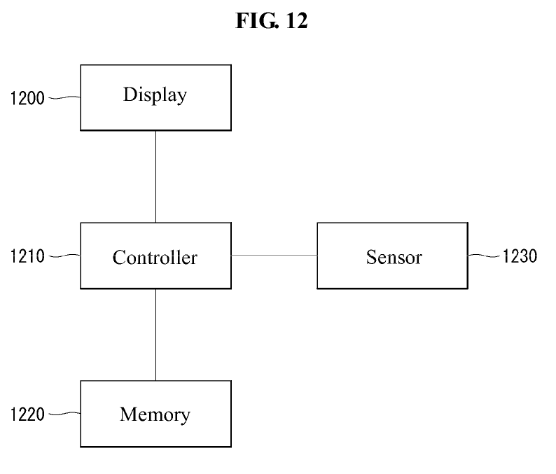

FIG. 12 is a block diagram illustrating a device according to an embodiment.

Referring to FIG. 12, the device includes a display 1200, a sensor 1230, a memory 1220, and a controller 1210.

The display 1200 displays visual information on a display screen. The visual information may indicate a still image, a video, an application execution screen, various interfaces, or visually expressible information. The display 1200 outputs the various visual information to the display screen based on a control command by the controller 1210. According to example embodiments, the display 1200 displays an interface provided in various modes.

The sensor 1230 senses a user input or an environment in which the device operates using at least one sensor provided in the device. For example, the at least one sensor may include a touch sensor, a fingerprint sensor, a motion sensor, a pressure sensor, a camera sensor, a tilt sensor, a gyrosensor, a gyroscope sensor, an angular velocity sensor, an illumination sensor, and an angle sensor. The various sensors described in the foregoing may be included in the device as separate elements, or be integrated into the device as at least one element.

The sensor 1230 may be provided in the display 1200. Thus, the device recognizes various user inputs made to the display 1200. For example, in a case of the sensor 1230 being the touch sensor, the device may sense various touch inputs made from a user to the display 1200. Here, a touch input may include a contact touch input and a contactless touch input, for example, a hovering input, to the display 1200. Also, the touch input may include all contact and contactless touch inputs made to the display 1200 using a tool, for example, a stylus pen and a touch pen, in addition to direct contact or contactless touch inputs made by a portion of a body of the user to the display 1200.

The sensor 1230 is controlled by the controller 1210, and transmits a result of the sensing to the controller 1210. The controller 1210 receiving the result of the sensing recognizes the user input or the environment in which the device operates.

The memory 1220 stores data including various sets of information. The memory 1220 may refer to a volatile and nonvolatile memory.

The controller 1210 controls at least one included in the device. The controller 1210 processes data in the device. In addition, the controller 1210 controls the at least one included in the device based on the recognized user input.

According to example embodiments, the controller 1210 provides or changes an entry mode, a child mode, and an adult mode. In addition, the controller 1210 determines whether a current user is a child using a user input to be recognized in the entry mode, and determines an entry into the child mode or the adult mode based on a result of the determining. For ease of description, the controller 1210 is described the same as the device.

Although not illustrated, the device may additionally include a speaker to output a sound and a tactile feedback unit to generate a tactile feedback, for example, a vibration.

The units of the device are separately illustrated in each block to logically distinguish each unit of the device. Thus, the units of the device may be provided as a single chip or a plurality of chips based on designing of the device.

For ease of description, example embodiments are described with reference to respective drawings. However, combining the example embodiments described with reference to the drawings to implement a new example embodiment may be possible. In addition, configurations and methods of the example embodiments are not restrictedly applied, and an entirety or a portion of the example embodiments may be selectively combined to allow various modifications to be made to the example embodiments.

Although a few desirable embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

### REFERENCE NUMERALS

500: Child identifying interface
510: Visual object
520-1, 520-2: User input

1. A method of controlling a display device, comprising:
providing an entry mode to determine an entry into an adult mode or a child mode through a child identifying interface comprising a visual object;
recognizing a user input in response to the visual object; and
providing the adult mode or the child mode based on a degree of similarity between the recognized user input and the visual object, and
wherein the child mode is a mode providing a selecting interface to select at least one application, and a time limit interface to terminate the application after executing, for a preset period of time, the application selected through the selecting interface.

2. The method of claim 1, wherein the providing of the adult mode or the child mode comprises:
providing the adult mode in response to the degree of similarity exceeding a threshold; and
providing the child mode in response to the degree of similarity being less than or equal to the threshold.

3. The method of claim 2, wherein the visual object comprises at least one line, and the user input in response to the visual object is a touch input moving along the at least one line comprised in the visual object.

4. The method of claim 3, further comprising:
determining the degree of similarity between the user input and the visual object by comparing touch input data of the recognized use input to reference data of the visual object.

5. The method of claim 4, wherein the touch input data comprises at least one of a trace, a size, a shape, a location, a length, a thickness, an area, and coordinate information of the recognized user input, and
the reference data comprises at least one of a trace, a size, a shape, a location, a length, a thickness, an area, and coordinate information of the visual object.

6. The method of claim 5, wherein the adult mode is a mode providing a setup interface to set the at least one application selectable in the child mode and the period of time.

7. The method of claim 6, wherein the adult mode additionally provides a difficulty level setting interface to set a difficulty level of the visual object, and
wherein, in response to an increase in the difficulty level, at least one of a number of lines, a number of contact points, a number of intersecting points, and a number of vertices comprised in the visual object, and a curvature of a line comprised in the visual object increases.

8. The method of claim 7, further comprising, when the visual object is provided as a character and the child mode is provided based on the recognized user input:
sequentially displaying a plurality of lines comprised in the visual object in a preset order.

9. The method of claim 7, further comprising, when the child mode is provided based on the recognized user input:
storing the recognized user input, and
wherein the adult mode provides a monitoring interface to chronologically display the stored user input.

10. The method of claim 9, wherein, when terminating the selected application, the time limit interface terminates the application through at least one additional effect of a visual effect, an auditory effect, and a tactile effect.

11. A display device, comprising:
a display configured to display visual information;
a sensor configured to sense a user input;
a memory configured to store data; and
a controller configured to control the display, the sensor, and the memory, and
wherein the controller is configured to provide an entry mode to determine an entry into an adult mode or a child mode through a child identifying interface comprising a visual object, recognize the user input in response to the visual object, and provide the adult mode or the child mode based on a degree of similarity between the recognized user input and the visual object, and
wherein the child mode is a mode providing a selecting interface to select at least one application and a time limit interface to terminate the application after executing, for a preset period of time, the application selected through the selecting interface.

12. The display device of claim 11, wherein the controller is configured to provide the adult mode in response to the degree of similarity exceeding a threshold, and provide the child mode in response to the degree of similarity being less than or equal to the threshold.

13. The display device of claim 12, wherein the visual object comprises at least one line, and the user input in response to the visual object is a touch input moving along the at least one line comprised in the visual object.

14. The display device of claim 13, wherein the controller is configured to determine the degree of similarity between the user input and the visual object by comparing touch input data of the recognized user input to reference data of the visual object.

15. The display device of claim 14, wherein the touch input data comprises at least one of a trace, a size, a shape, a location, a length, a thickness, an area, and coordinate information of the recognized user input, and
the reference data comprises at least one of a trace, a size, a shape, a location, a length, a thickness, an area, and coordinate information of the visual object.

16. The display device of claim 15, wherein the adult mode is a mode providing a setup interface to set the at least one application selectable in the child mode and set the period of time.

17. The display device of claim 16, wherein the adult mode additionally provides a difficulty level setting interface to set a difficulty level of the visual object, and
wherein, in response to an increase in the difficulty level, at least one of a number of lines, a number of contact points, a number of intersecting points, and a number of vertices comprised in the visual object, and a curvature of a line comprised in the visual object increases.

18. The display device of claim 17, wherein, when the visual object is provided as a character and the child mode is provided based on the recognized user input, the controller is configured to control the display to sequentially display a plurality of lines comprised in the visual object in a preset order.

19. The display device of claim 17, wherein, when the child mode is provided based on the recognized user input, the controller is configured to store the recognized user input in the memory, and provide a monitoring interface to chronologically display the stored user input through the adult mode.

20. The display device of claim 19, wherein, when terminating the selected application, the time limit interface terminates the selected application through at least one additional effect of a visual effect, an auditory effect, and a tactile effect.
